(19) United States
(12) Patent Application Publication
(10) Pub. No.: US 2018/0251156 A1
(43) Pub. Date: Sep. 6, 2018

(54) Dynamic Camber Adjustment

(71) Applicant: Axel Michael Sigmar, Lago Vista, TX (US)

(72) Inventor: Axel Michael Sigmar, Lago Vista, TX (US)

(21) Appl. No.: 15/859,490

(22) Filed: Dec. 30, 2017

Related U.S. Application Data
(60) Provisional application No. 62/440,984, filed on Dec. 30, 2016.

(51) Int. Cl. B62D 17/00; B60G 5/04

(52) U.S. Cl. CPC B62D 17/00; B60G 2200/46; B60G 5/043

(57) ABSTRACT

In some embodiments, an apparatus may include a frame structure including a first end configured to couple to a frame of a vehicle and including a second end. The second end includes an upper attachment element and a lower attachment element. The apparatus further includes a camber housing coupled between the lower attachment element and a wheel. The camber housing includes a guide element and configured to pivot about the lower attachment element. The apparatus includes a slider coupled to the upper attachment element and configured to move along the guide element to provide a dynamically and continuously variable adjustable camber angle.

### CROSS-REFERENCE TO RELATED APPLICATION(S)

This application is a non-provisional of and claims priority to U.S. Provisional Patent Application No. 62/440,984 filed on Dec. 30, 2016 and entitled “Active Series Hybrid Integrated Electric Vehicle”, which is incorporated herein by reference in its entirety.

### FIELD

The present disclosure is generally related to vehicles that include at least three wheels, and more particularly to a vehicle including a plurality of wheels where each wheel includes a camber angle adjustment feature configured to dynamically adjust the camber angle of the wheel relative to the frame of the vehicle and independently from the other wheels.

### BACKGROUND

Industrial vehicles and passenger vehicles typically include an engine, a transmission coupling the engine to driving wheels, and a pair of steerable wheels. The steerable wheels may be controlled by a steering wheel or other steering device provided adjacent to a driver's seat. In many cars and trucks, the steering mechanisms may be aided by power steering mechanisms to assist the driver in turning the wheels.

In general, each of the wheels of the vehicle defines a camber angle relative to a surface. The camber angle may represent a measure in degrees of a difference between the perpendicular (vertical) angle of a wheel and an angle of the circumferential center line of the wheel relative to a surface. When the wheel is perpendicular to the surface, the camber angle is zero degrees. Generally, the camber angle is negative when the top of the wheel tilts toward the fender walls of the vehicle and is positive when the top of the wheel tilts away from the fender walls of the vehicle.

### SUMMARY

In some embodiments, an apparatus may include a frame structure including a first end configured to couple to a frame of a vehicle and including a second end. The second end includes an upper attachment element and a lower attachment element. The apparatus further includes a camber housing coupled between the lower attachment element and a wheel. The camber housing includes a guide element and configured to pivot about the lower attachment element. The apparatus includes a slider coupled to the upper attachment element and configured to move along the guide element to provide a dynamically and continuously variable adjustable camber angle.

In other embodiments, a system may include a control circuit, a frame of a vehicle, and at least one wheel module coupled to the frame of the vehicle. The wheel module may include a wheel and an actuator responsive to a signal from the control circuit to selectively adjust a camber angle of the wheel during operation.

In still other embodiments, a method of providing dynamic camber adjustments includes receiving signals from a plurality of sensors at a control circuit. The method further includes determining a plurality of camber adjustments based on the received signals and selectively adjusting a camber angle of a wheel of each of a plurality of wheel modules by sending one or more control signals to an actuator of each of the plurality of wheel modules.

### BRIEF DESCRIPTION OF THE DRAWINGS

FIG. 1 depicts a perspective view of a vehicle including a plurality of wheels, each of which includes an active camber adjustment feature, in accordance with certain embodiments of the present disclosure.

FIG. 2 depicts a block diagram of a system configured to provide a dynamic camber adjustment, in accordance with certain embodiments of the present disclosure.

FIG. 3 depicts an exploded perspective view of structural components configured to provide a dynamic camber adjustment, in accordance with certain embodiments of the present disclosure.

FIG. 4 depicts a front perspective view of a portion of a vehicle including wheel modules configured to provide dynamic camber adjustments independently, in accordance with certain embodiments of the present disclosure.

FIG. 5 depicts a method of dynamic camber adjustment, in accordance with certain embodiments of the present disclosure.

FIG. 6 depicts a method of dynamic camber adjustment, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of systems, methods, and devices are described below that can be configured to provide independent camber angle adjustments, dynamically. Camber angle can impact the handling of a particular suspension design, in part, because the camber angle can be adjusted to maintain a consistent contact patch between the tire and the road surface during cornering and during straight-line acceleration or deceleration. For example, the systems, methods, and devices may dynamically adjust the camber angle of a first wheel module to provide a negative camber angle and to adjust a second wheel module to provide a positive camber angle. In this example, the first wheel module may include a tire on the outside of a turn, while the second wheel module may include a tire on the inside of the turn. By dynamically adjusting the camber angle of each tire independently, the handling in and out of turns can be enhanced without compromising straight-line or lateral acceleration, which has the best traction when the camber angle is zero allowing the tread to lie flat on the road.

The active camber adjustment can be used to maintain a desired (optimal) contact patch between the tire and the road surface. In conjunction with an active suspension which can lean the vehicle into turns and minimize nose dive when braking, the active camber adjustment can improve cornering and braking, prevent accidents, prevent rollovers (tipping), and improve overall safety of the vehicle.

Further, in combination with a steerable, driven wheel module, the vehicle dynamic performance and stability can be greatly enhanced. Active camber adjustment control can be essential for large vehicles with varying loads and load conditions.

Embodiments of systems, methods, and devices may include a mounting frame, a camber adjustment housing including a guide element, and a slider configured to move back and forth along the guide element of the camber adjustment housing. The mounting frame may include vehicle frame attachment features configured to couple to a frame of a vehicle, a first attachment feature configured to couple to the camber adjustment housing, and a second attachment feature configured to couple to the guide element. The camber adjustment housing may be configured to couple the mounting frame to a wheel of a vehicle. The device may further include a motor configured to fit within an enclosure formed by the camber adjustment housing and configured to move the slider along the guide element to adjust a camber angle of the tire. Other embodiments are also possible.

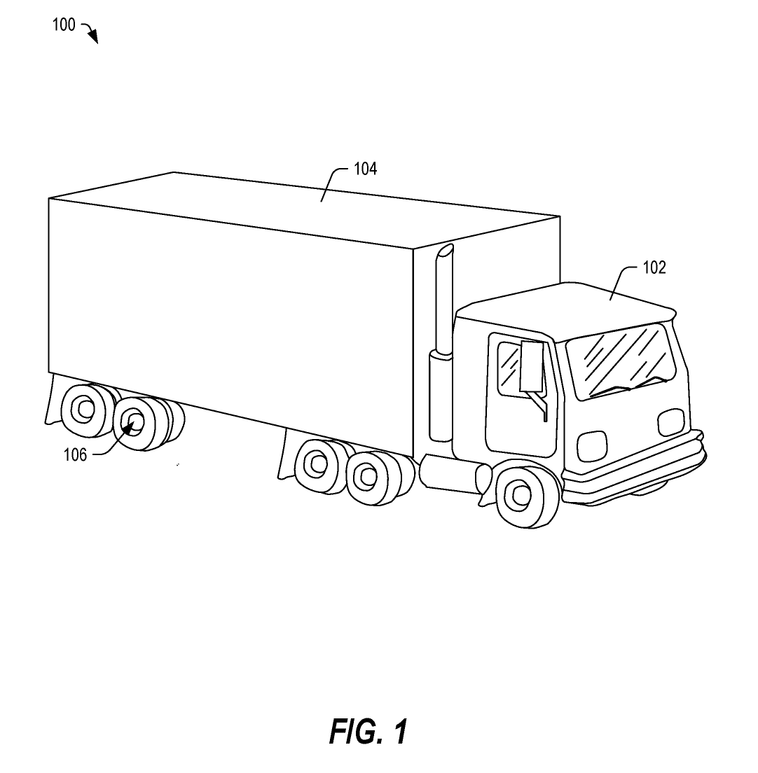

FIG. 1 depicts a perspective view of a vehicle 100 including a plurality of wheels, each of which includes an active camber adjustment feature, in accordance with certain embodiments of the present disclosure. The vehicle 100 may include a cab 102 and a trailer 104 including a plurality of wheel modules 106. Each wheel module 106 may include one or more tires and a coupling assembly. The coupling assembly may include a dynamic camber adjustment feature, which may be controlled to provide a camber adjustment for the associated wheel module 106 independently from the camber adjustment of any of the other wheel modules 106.

In an example, during a turning operation, one or more of the wheel modules 106 on a first side of the vehicle 100 (both with respect to the cab 102 and the trailer 104) may be adjusted to provide a positive camber angle, and one or more of the wheel modules 106 on the second side of the vehicle 100 may be adjusted to provide a negative camber angle. The wheel modules 106 may be adjusted to provide a neutral or zero camber angle during straight line acceleration or deceleration. The camber adjustments may differ from one wheel module 106 to a next wheel module 106 on the same side of the vehicle 100.

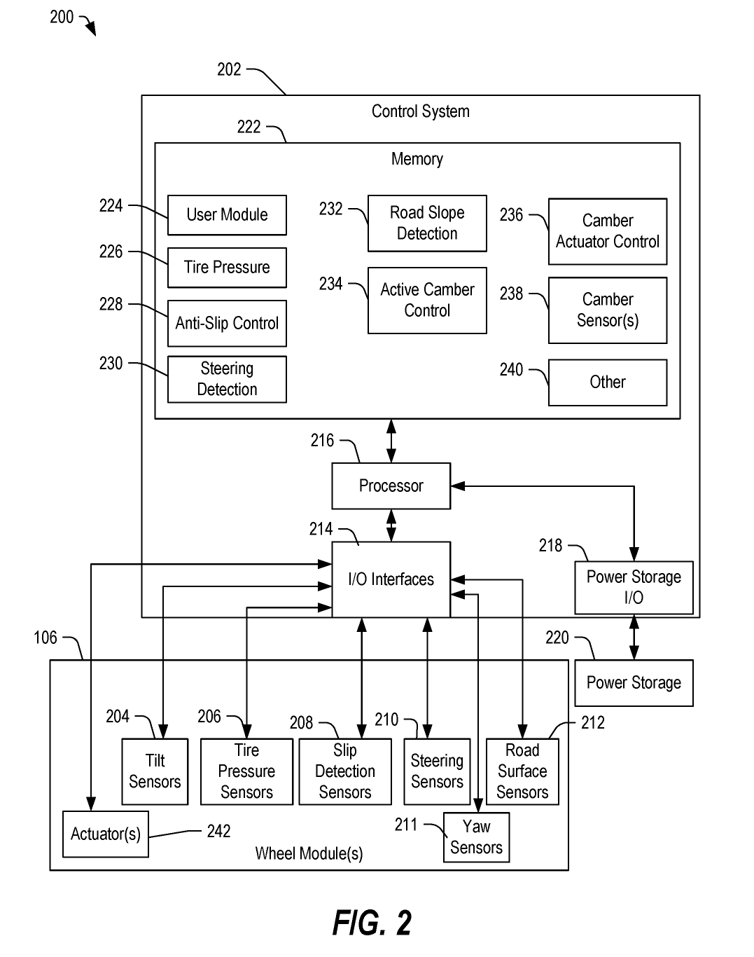

In some embodiments, the camber adjustment feature may include an actuator that can be controlled via a control signal from a control system (e.g., control system 202 in FIG. 2). The actuator may be controlled to adjust the camber angle of the wheel of the wheel module 106.

FIG. 2 depicts a block diagram of a system 200 configured to provide a dynamic camber adjustment, in accordance with certain embodiments of the present disclosure. The system 200 may include a control system 202 coupled to a plurality of sensors associated with each of the wheel modules 106. The sensors may include tilt sensors 204, tire pressure sensors 206, slip detection sensors 208, steering sensors 210, yaw sensors 211, and road surface sensors 212. Each sensor 204, 206, 208, 210, 211, and 212 may provide a signal proportional to a sensed parameter to the control system 202.

The control system 202 may include one or more input/output (I/O) interfaces 214. The I/O interfaces 214 may be coupled to or otherwise configured to receive signals from the sensors 204, 206, 208, 210, 211, and 212. The I/O interfaces 214 may be coupled to a processor 216, which may be coupled to power storage 220 (such as a plurality of batteries) via a power storage I/O interface 218. The processor 216 may also be coupled to a memory 222, which may be configured to store processor-executable instructions as well as data.

The memory 222 may include a graphical user interface (GUI) module 224 that, when executed, can cause the processor 216 to provide a graphical interface through which a user may interact with the control system 202. In some embodiments, the I/O interfaces 214 may be coupled to a touchscreen interface or other input device to view and configure the camber settings of the system.

The memory 222 may also include a tire pressure module 226 that, when executed, may cause the processor 216 to determine the tire pressure associated with the one or more tires of the wheel module 106. The memory 222 may further include an anti-slip control module 228 that, when executed, may cause the processor 216 to determine a slip parameter associated with each tire of a wheel module 106.

The memory 222 may further include a steering detection module 230 that, when executed, may cause the processor 216 to determine changes in steering direction from a control interface, such as a steering wheel, a control circuit, another source, or any combination thereof. The memory 222 may also include a road slope detection module 232 that, when executed, may cause the processor 216 to determine a shape or slope of a road surface.

The memory 222 includes an active camber control module 234 that, when executed, may cause the processor 216 to determine a camber adjustment for each tire based, at least in part, on the determined tire pressure, the anti-slip parameter, the steering direction changes, and the determined shape or slope of the road surface. The memory 222 may further include a camber actuator control module 236 that, when executed, may cause the processor 216 to selectively provide camber adjustment control signals to the actuators 242 of the wheel module 106 to provide a selected camber angle adjustment for each tire. The camber actuator control module 236 may selectively adjust the camber angle of each tire, independently. Further, the camber actuator control module 236 may control the timing of the actuator such that the timing and magnitude of the camber angle adjustment may vary from wheel module to wheel module or even from tire to tire.

The memory 222 may also include a camber sensor(s) module 238 that, when executed, may cause the processor 216 to determine the camber angle of each tire. In some embodiments, the camber angle may be determined based on signals from the tilt sensors 204 and the road surface sensors 212. In other embodiments, the camber angle may be determined, in part, relative to a frame of the vehicle 100. Other embodiments are also possible.

The memory 222 may also include other modules 240. The other modules 240 may cause the processor 216 to control operation of the vehicle, to control operation of one or more actuators (such as gate lift actuators, compression actuators, and the like). Further, in the context of an electrical vehicle, the other modules 240 may include battery status modules, active suspension control modules, motor control modules, other modules, or any combination thereof.

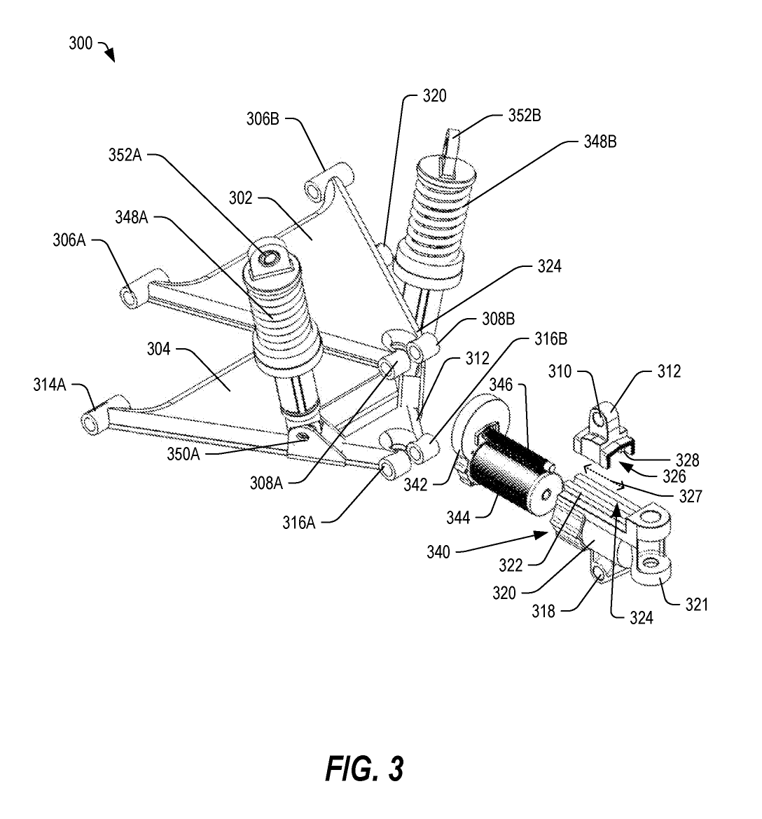

FIG. 3 depicts an exploded perspective view of structural components 300 configured to provide a dynamic camber adjustment, in accordance with certain embodiments of the present disclosure. The structural components 300 may include an upper mounting frame 302 and a lower mounting frame 304. The upper mounting frame 302 includes frame attachment elements 306A and 306B, which may be cylindrical structures sized to receive fasteners (such as a bolts) to couple the frame attachment elements 306A and 306B to corresponding features on the frame of the vehicle. The upper mounting frame 302 further includes slider attachment elements 308A and 308B, which may be cylindrical structures sized to receive a fastener (such as a bolt) to couple the slider attachment element 308A and 308B to a corresponding receptacle 310 of a slider 312.

The lower mounting frame 304 includes frame attachment elements 314A and a corresponding element that is obscured from view by the upper mounting frame 302. The frame attachment element 314A and its corresponding element on the obscured edge of the lower mounting frame 304 may include cylindrical structures sized to receive fasteners (such as bolts) to couple the frame attachment elements 314 to the frame of the vehicle. The lower mounting frame 304 further includes camber housing attachment elements 316A and 316B, which may be cylindrical structures sized to receive a fastener (such as a bolt) to couple the camber housing attachment elements 316A and 316B to a corresponding receptacle 318 of a camber housing 320.

The camber housing 320 may include a guide element 322 including a central groove 324 forming tracks along an upper surface of the camber housing 320. The guide element 322 may be sized to receive a corresponding recess 326 of the slider 312. The recess 326 includes side walls spaced apart to fit over the guide element 322 of the camber housing 320. The recess 326 may include a ridge or extension 328 within the recess 326 to engage the central groove 324. The slider 312 may be configured to slide back and forth along the guide element 322 as indicated by the phantom arrow 327.

The camber housing 320 may define an enclosure 340 sized to receive a portion of an actuator 342, which may include a worm drive having a rotatable gear 344 configured to engage corresponding threads of an articulating shaft 346 configured to move the slider 312 along the guide element 322. The actuator 342 may be an embodiment of the actuator 242 in FIG. 2. The camber housing 320 may further include a coupling 321 configured to receive a king pin or other fastener to secure a steering knuckle or other structure to the camber housing 320. In some embodiments, a wheel including a rim and a tire may be coupled to the steering knuckle. In a particular example, the actuator 324 may be controlled to adjust the position of the slider 312 relative to the housing 320 to adjust the camber angle of the wheel.

The structural components 300 may further include suspension springs 348A and 348B. The suspension spring 348A may be coupled at a proximal end to a spring attachment element 350A of the lower mounting structure 304 via a fastener, such as a bolt. The distal end of the suspension spring 348A may include a frame attachment element 352A configured to couple to a corresponding attachment feature of the frame of the vehicle. Similarly, the suspension spring 348B may be coupled between a spring attachment element 350B (which is obscured by the upper mounting frame 302) and a frame attachment element 352B, which may be coupled to the frame of the vehicle.

It should be understood that the structural components 300 may be included with each of the wheel modules of the vehicle, making it possible to dynamically adjust the camber angle of each wheel independent from every other wheel. Thus, each wheel can have an independently adjustable camber angle to maintain consistent road surface contact in various road conditions and in response to changing directions. Further, it should be appreciated that the camber angle adjustments may be implemented dynamically as the vehicle is in motion, in order to maintain a desired contact patch between the tire and the road surface.

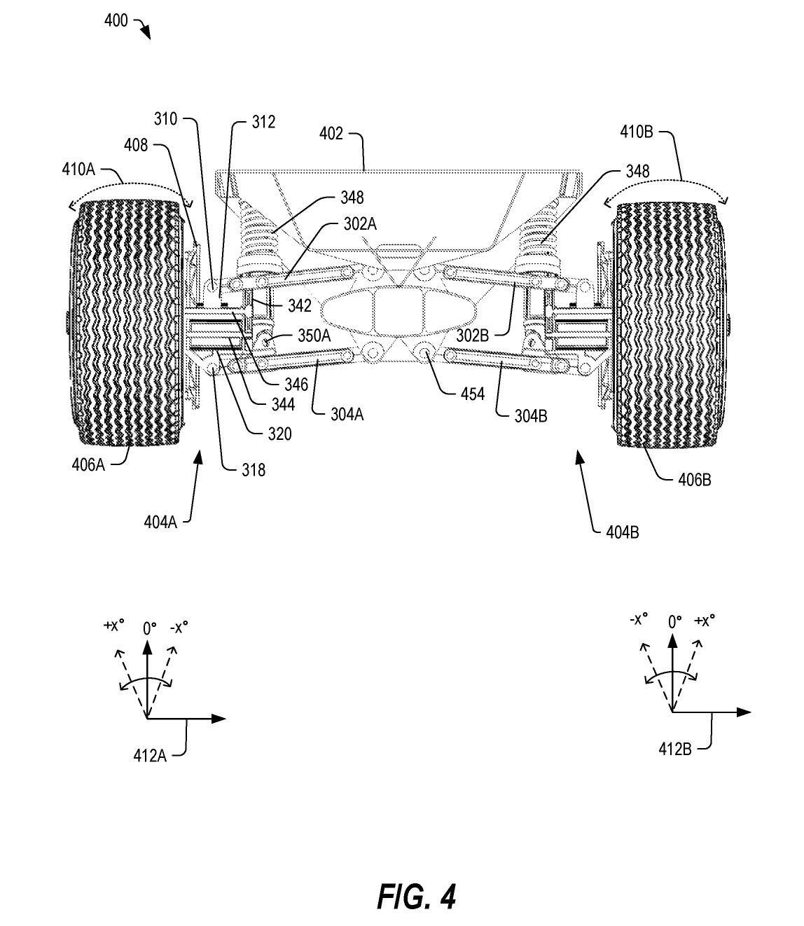

FIG. 4 depicts a front perspective view of a portion of a vehicle 400 including wheel modules 404 configured to provide dynamic camber adjustments independently, in accordance with certain embodiments of the present disclosure. The vehicle 400 may include a frame 402 coupled to wheel modules 404A and 404B, each of which includes the structural components 300 of FIG. 3, a respective tire 406A and 406B, and a steering knuckle 408 connected to the coupling 321 of FIG. 3.

In the illustrated example, by controlling the actuator 342, the rotatable gear 344 configured to engage corresponding threads of the articulating shaft 346 to move the camber housing 320 relative to the tire 406 and the frame 402. The slider 312 may move along the guide 322 (shown in FIG. 3) while the receptacle 318 of the camber housing 320 remains rigidly coupled to the lower mounting frame 304A. The bolt extending through the receptacle 318 and the camber housing attachment elements 316 of the lower mounting frame 304 provides a pivot point about which the camber housing 320 may rotate, allowing the tire 410 to tilt to adjust the camber angle of the tire 406.

In general, the slider 312, the guide element 322 (in FIG. 3), the camber housing 320, the upper mounting frame 302, the lower mounting frame 304, and the actuator 342 (with the gear 344 and the shaft 346) allow the camber of each tire 406A and 406B to be controlled dynamically and independently. As shown, the tire 406A and the tire 406B may be tilted according to the arrows 410A and 410B, respectively. In particular, the tires 406A and 406B are shown with camber angles of zero, which represents an angle that is approximately perpendicular relative to the ground. The tire 406A can have an adjustable camber angle 412A that can be controlled to provide an adjustable camber angle 412A that can range from a positive camber angle to a negative camber angle. The tire 406B can have an adjustable camber angle 412B that can be controlled to provide an adjustable camber angle 412B that can range from a positive camber angle to a negative camber angle. The adjustable camber angles 412A and 412B may be adjusted independently from one another, both in terms of the camber angle and the timing of the variation.

In some embodiments, a control system or control circuit (such as the system 200 in FIG. 2) may be housed within an enclosed portion of the frame 402 of the vehicle 400 and may be coupled to the actuator 342 and to a plurality of sensors (not shown) via wired connections. In some examples, the control circuit or control system may determine various parameters of the tire, the road pitch, the road conditions, and the steering control signals and may selectively adjust the camber angle of each of the tires 406A and 406B. In an example, during a turn, the tire 406A may be adjusted to provide a first camber angle 412A, and the tire 406B may be adjusted to provide a second camber angle 412B. The first and second camber angles 412A and 412B may be adjusted to have different camber angles (one positive and one negative, one negative and one more negative, one zero and one negative, etc.). Any combination of positive, negative, and zero camber angles may be provided, depending on the desired performance characteristics. It should be appreciated that the camber angles may also differ in magnitude, such that the negative camber angle of one tire may have an absolute value that is greater than a positive camber angle of another tire, and so on. In a turning situation involving a vehicle having multiple tires, the tires 406 on the outside of the turn may each have a negative camber angle that differs from that of an adjacent tire to enhance the tire contact patch for each tire independently. Similarly, the tires 406 on the inside of the turn may each have a positive camber angle that differs from that of an adjacent tire to enhance the tire contact patch for each tire independently. Other embodiments are also possible.

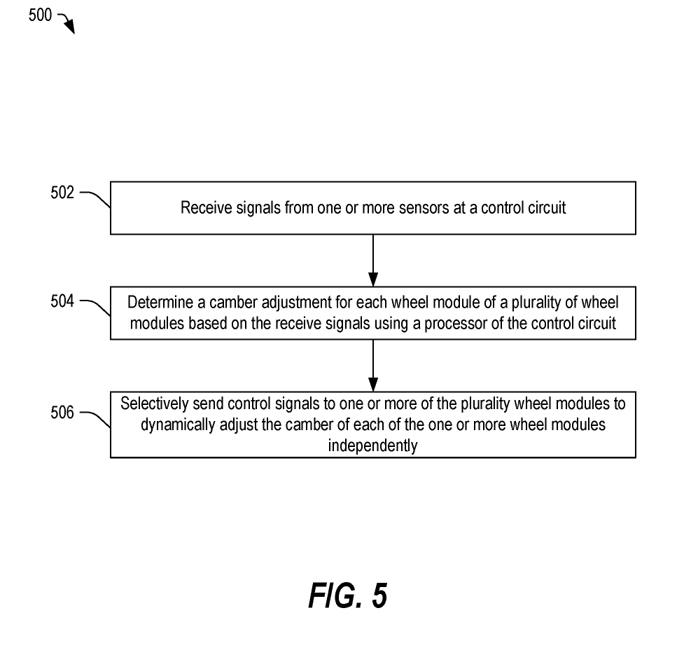

FIG. 5 depicts a method 500 of dynamic camber adjustment, in accordance with certain embodiments of the present disclosure. At 502, the method 500 may include receiving signals from one or more sensors at a control circuit. The sensors may include tilt sensors, tire pressure sensors, slip detection sensors, steering sensors, road surface sensors, other sensors, or any combination thereof.

At 504, the method 500 can include determining a camber adjustment for each wheel module of a plurality of wheel modules based on the received signals using a processor of the control circuit. The camber adjustment may include a differential between a current camber angle of the wheel module and a desired camber angle.

At 506, the method 500 may include selectively sending control signals to one or more of the plurality of wheel modules to dynamically adjust the camber of each of the one or more wheel modules independently. A control signal may be sent to an actuator associated with the camber housing of each wheel module, and the control signal may vary from wheel module to wheel module to provide a selected, independent camber adjustment for each wheel module. In a particular example, the control circuit may control the amplitude of the camber adjustment provided to each of the wheel modules independently. Further, the control circuit may control timing of the implementation of the camber adjustment by controlling timing of the transmission of the control signals to each of the wheel modules to provide a selected camber adjustment for each wheel module at a selected time. Other embodiments are also possible.

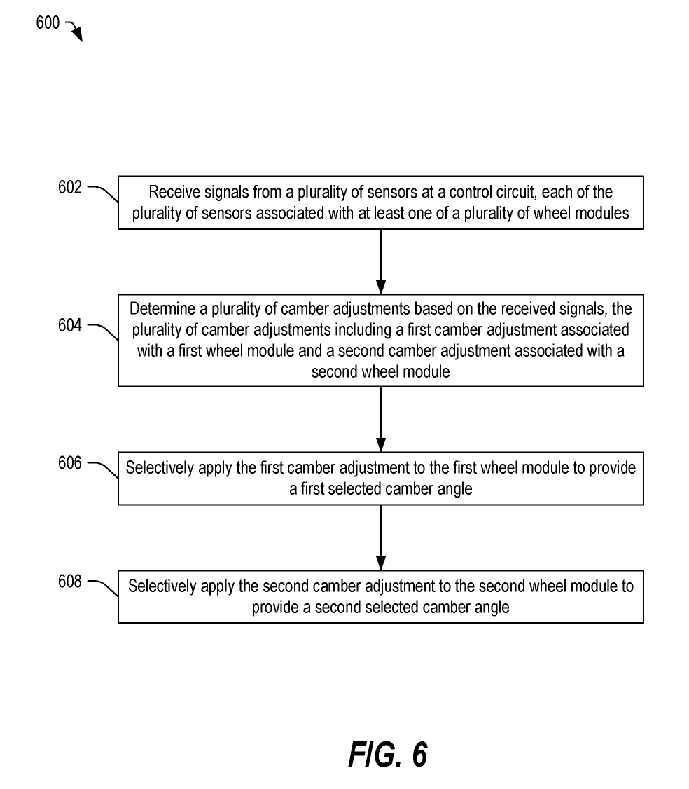

FIG. 6 depicts a method 600 of dynamic camber adjustment, in accordance with certain embodiments of the present disclosure. At 602, the method 600 may include receiving signals from a plurality of sensors at a control circuit, where each of the plurality of sensors is associated with at least one of a plurality of wheel modules. The sensors may include tilt sensors, tire pressure sensors, slip detection sensors, steering sensors, road surface sensors, other sensors, or any combination thereof. In an example, each wheel module may include a plurality of sensors, each of which provides a signal to the control circuit that is proportional to a parameter to be measured.

At 604, the method 600 may include determining a plurality of camber adjustments based on the received signals, the plurality of camber adjustments including a first camber adjustment associated with a first wheel module and a second camber adjustment associated with a second wheel module. In an example, each wheel module may include one or more tires, and the camber adjustment may be performed on the one or more tires.

At 606, the method 600 may include selectively applying the first camber adjustment to the first wheel module to provide a first selected camber angle. In an example, the camber adjustment is applied by controlling an actuator or motor of the first wheel module to alter the camber angle of the one or more tires.

At 608, the method 600 may include selectively applying the second camber adjustment to the second wheel module to provide a second selected camber angle. In an example, the camber adjustment is applied by controlling an actuator or motor of the second wheel module to alter the camber angle of the one or more tires.

It should be understood that the flow diagrams of FIGS. 5 and 6 are provided for illustrative purposes only. Steps may be omitted or combined without departing from the scope of the present disclosure. Further, it should be appreciated that the first camber adjustment and the second camber adjustment may be different. Additionally, the first camber adjustment may be applied at a first time, and the second camber adjustment may be applied at a second time. Other embodiments are also possible.

In conjunction with the systems, methods, and devices described above with respect to FIGS. 1-6, an apparatus may include a camber housing with a guide element that is coupled to the frame of a vehicle is configured to engage a slider, which is also coupled to the frame of the vehicle. The camber housing may enclose at least a portion of an actuator, which can be selectively controlled to adjust a camber angle of an associated tire. The camber angle can be adjusted dynamically, during operation, based at least in part on the operating conditions to maintain a desired performance characteristic.

Although the present invention has been described with reference to preferred embodiments, workers skilled in the art will recognize that changes may be made in form and detail without departing from the scope of the invention.

What is claimed is:

1. An apparatus comprising:
a frame structure including a first end configured to couple to a frame of a vehicle and including a second end, the second end including an upper attachment element and a lower attachment element;
a camber housing coupled between the lower attachment element and a wheel, the camber housing including a guide element and configured to pivot about the lower attachment element; and
a slider coupled to the upper attachment element and configured to move along the guide element to provide an adjustable camber angle.

2. The apparatus of claim 1, further including an actuator disposed within the camber housing and responsive to a control signal to move the camber housing laterally relative to the frame of the vehicle.

3. The apparatus of claim 2, wherein the camber housing pivots about the lower attachment element in response to the control signal.

4. The apparatus of claim 2, wherein the actuator comprises a worm drive including a rotatable gear and a shaft configured to engage the gear.

5. The apparatus of claim 1, wherein the slider includes a recessed portion sized to fit over the guide element.

6. The apparatus of claim 5, wherein:
the guide element includes a center groove; and
the recessed portion of the slider includes a ridge or extension configured to fit within the center groove.

7. A system comprising:
a control circuit;
a frame of a vehicle;
at least one wheel module coupled to the frame of the vehicle, the at least one wheel module including:
a wheel; and
an actuator responsive to a signal from the control circuit to selectively adjust a camber angle of the wheel during operation.

8. The system of claim 7, wherein:
the at least one wheel module includes a plurality of sensors including at least one of a tilt sensor, an anti-slip control sensor, a vehicle yaw sensor, and a steering angle sensor; and
the control circuit generates the signal to adjust the camber angle in response to a signal from at least one of the plurality of sensors.

9. The system of claim 7, wherein the at least one wheel module includes:
a frame structure including a first end configured to couple to the frame of the vehicle and including a second end, the second end including an upper attachment element and a lower attachment element;
a camber housing coupled between the lower attachment element and the wheel, the camber housing including a guide element and configured to pivot about the lower attachment element; and
a slider coupled to the upper attachment element and configured to move along the guide element to provide an adjustable camber angle.

10. The system of claim 9, wherein the actuator is coupled to at least one of the camber housing and the slider.

11. The system of claim 9, wherein the actuator is disposed within the camber housing and responsive to a control signal to move the camber housing longitudinally relative to the frame of the vehicle.

12. The system of claim 9, wherein the camber housing pivots about the lower attachment element in response to the control signal.

13. The system of claim 9, wherein the actuator comprises a worm drive including a rotatable gear and a shaft configured to engage the gear.

14. The system of claim 9, wherein the slider includes a recessed portion sized to fit over the guide element.

15. The system of claim 14, wherein:
the guide element includes a center groove; and
the recessed portion of the slider includes a ridge or extension configured to fit within the center groove.

16. A method of providing dynamic camber adjustments, the method comprising:
receiving signals from a plurality of sensors at a control circuit;
determining a plurality of camber adjustments based on the received signals;
dynamically adjusting a camber angle of a wheel of each of the plurality of wheel modules by sending one or more control signals to an actuator of each of the wheel modules.

17. The method of claim 16, wherein dynamically adjusting the camber angle comprises:
sending a first control signal to a first actuator of a first wheel module of the plurality of wheel modules to cause the first actuator to provide a first camber adjustment; and
sending a second control signal to a second actuator of a second wheel module of the plurality of wheel modules to cause the second actuator to provide a second camber adjustment.

18. The method of claim 17, further comprising selectively controlling timing of the sending of the first control signal and the sending of the second control signal to provide the first camber adjustment at a first time and the second camber adjustment at a second time.

19. The method of claim 17, wherein the first camber adjustment is different from the second camber adjustment.

20. The method of claim 16, wherein selectively adjusting a camber angle of a wheel of each of the plurality of wheel modules by sending one or more control signals to an actuator of each of the wheel modules comprises:
controlling the actuator to move a camber housing relative to a frame of a vehicle, the camber housing pivotally coupled to lower mounting frame that is coupled to the frame of the vehicle, the camber housing coupled between the lower mounting frame and the wheel of one of the plurality of wheel modules; and
allowing a slider to move along a guide element of the camber housing, the slider coupled to an upper mounting that is coupled to the frame of the vehicle; and
wherein movement of the camber housing relative to the frame causes the camber housing to pivot about a pivot point defined at a coupling between the camber housing and the lower mounting frame to adjust the camber angle of the wheel.
